(19) United States
(12) Patent Application Publication
(10) Pub. No.: US 2026/0281365 A1
(43) Pub. Date: Sep. 17, 2026

(54) METHODS AND APPARATUSES FOR ENCODING AND DECODING AN IMAGE OR A VIDEO

(71) Applicant: InterDigital CE Patent Holdings, SAS, Paris (FR)

(72) Inventors: Fabrice LE LEANNEC, BETTON (FR); Karam NASER, MOUAZE (FR); Gagan Bihari RATH, RENNES (FR); Franck GALPIN, THORIGNE-FOUILLARD (FR)

(21) Appl. No.: 19/473,015

(22) PCT Filed: Mar. 26, 2024
(86) PCT No.: PCT/EP2024/058165

§ 371 Date: Oct. 6, 2025

(30) Foreign Application Priority Data
Apr. 6, 2023 (EP) 23305504.5

(51) Int. Cl. H04N 19/136; H04N 19/159; H04N 19/176; H04N 19/70

(52) U.S. Cl. CPC H04N 19/136; H04N 19/159; H04N 19/176; H04N 19/70

(57) ABSTRACT

A method and an apparatus for encoding or decoding an image or a video are provided. Responsive to a determination that an image block is encoded using an intra block copy coding mode, a block predictor is determined for the image block based on one or more candidate block vector predictors, wherein the one or more candidate block vector predictors comprises at least one candidate block vector predictor determined using an intra template matching coding mode. The image block is encoded or decoded using the determined block predictor.

This application claims the priority to European Application No. 23305504.5, filed on 6 Apr. 2023, which is incorporated herein by reference in its entirety.

### TECHNICAL FIELD

The present embodiments generally relate to video compression. The present embodiments relate to a method and an apparatus for encoding or decoding an image or a video. More particularly, the present embodiments relate to improving intra prediction coding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. In inter prediction, motion vectors used in motion compensation are often predicted from motion vector predictor. To reconstruct the video, the compressed data are decoded by inverse processes corresponding to the entropy coding, quantization, transform, and prediction.

### SUMMARY

According to an aspect, a method for encoding a video is provided. The method comprises responsive to a determination that an image block is encoded using an intra block copy coding mode, determining a block predictor for the image block based on one or more candidate block vector predictors, wherein the one or more candidate block vector predictors comprises at least one candidate block vector predictor determined using an intra template matching coding mode, and encoding the image block using the determined block predictor.

According to another aspect, an apparatus for encoding a video is provided. The apparatus comprises one or more processors operable to responsive to a determination that an image block is encoded using an intra block copy coding mode, determine a block predictor for the image block based on one or more candidate block vector predictors, wherein the one or more candidate block vector predictors comprises at least one candidate block vector predictor determined using an intra template matching coding mode, and encode the image block using the determined block predictor.

According to another aspect, a method for decoding a video is provided. The method comprises responsive to a determination that an image block is encoded using an intra block copy coding mode, determining a block predictor for the image block based on one or more candidate block vector predictors, wherein the one or more candidate block vector predictors comprises at least one candidate block vector predictor determined using an intra template matching coding mode, and decoding the image block using the determined block predictor. According to another aspect, an apparatus for decoding a video is provided. The apparatus comprises one or more processors operable to responsive to a determination that an image block is encoded using an intra block copy coding mode, determine a block predictor for the image block based on one or more candidate block vector predictors, wherein the one or more candidate block vector predictors comprises at least one candidate block vector predictor determined using an intra template matching coding mode, and decode the image block using the determined block predictor.

Further embodiments that can be used alone or in combination are described herein.

One or more embodiments also provide a computer program comprising instructions which when executed by one or more processors cause the one or more processors to perform the method for encoding/decoding a video according to any of the embodiments described herein. One or more of the present embodiments also provide a non-transitory computer readable medium and/or a computer readable storage medium having stored thereon instructions for encoding/decoding a video according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIG. 4 illustrates a coding tree unit processing order and its available reference samples in the coding tree unit and the left coding tree unit.

FIG. 5 illustrates an example of padding candidates for the replacement of the zero-vector in an IBC list.

FIG. 6 illustrates an example of an extended reference region for IBC.

FIG. 7 illustrates an example of intra template matching search area.

FIG. 8 illustrates an example of a flowchart of a method for encoding an image or a video according to an embodiment.

FIG. 9 illustrates an example of a flowchart of a method for decoding an image or a video according to an embodiment.

FIG. 10 illustrates an example of a flowchart of a method for decoding a coding unit or block according to an embodiment.

FIG. 11 illustrates an example of a flowchart of a method for decoding a coding unit or block according to another embodiment.

FIG. 12 illustrates a block diagram of a system within which aspects of the present embodiments may be implemented, according to another embodiment.

FIG. 13 shows two remote devices communicating over a communication network in accordance with an example of the present principles.

FIG. 14 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

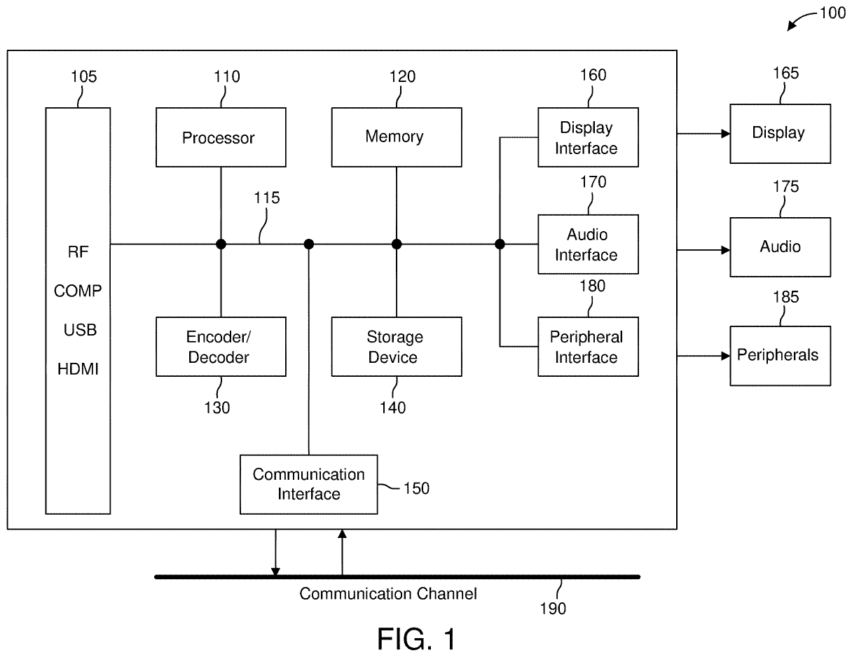

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, standard developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

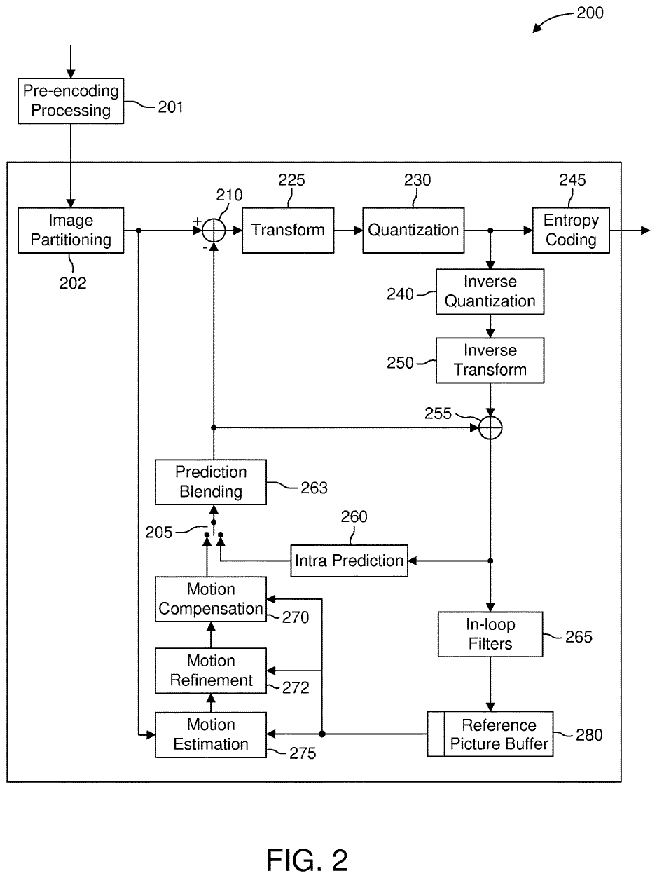

FIG. 2 illustrates a video encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder ECM under development by JVET (Joint Video Exploration Team). Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. In the disclosure, different expressions may be used to refer to such a unit or block resulting from a partitioning of the picture. Such wording may be coding unit or CU, coding block or CB, luminance CB, or block. A CTU (Coding Tree Unit) may refer to a group of blocks or group of units. In some embodiments, a CTU may be considered as a block, or a unit as itself.

Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

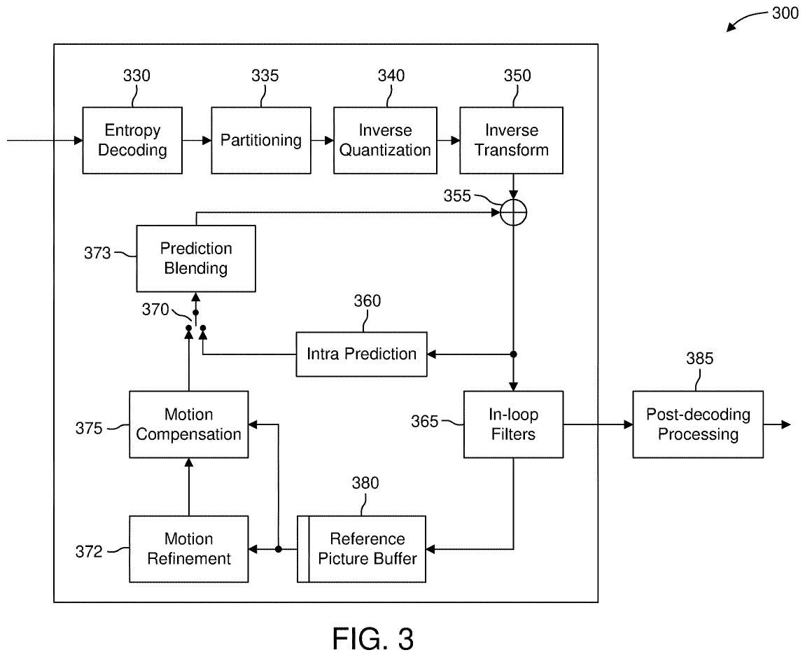

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

Some of the embodiments described herein relates to intra or inter prediction and more particularly to intra block copy coding mode.

Any one of the embodiments described herein can be implemented for instance in an intra prediction module 260 of the video encoder 200 or an intra prediction module 360 of the video decoder 300.

Intra block copy (IBC) is a tool used in HEVC and VVC for screen content coding. It is well known that it significantly improves the coding efficiency of screen content materials.

Since IBC mode is implemented as a block level coding mode, block matching (BM) is performed at the encoder to find an optimal block vector (or motion vector) for each CU (coding unit) or block. A block vector indicates the displacement from the current block to a reference block (or predictor block), which is already reconstructed inside the current picture.

The luma block vector of an IBC-coded CU is in integer precision. The chroma block vector rounds to integer precision as well. When combined with AMVR, the IBC mode can switch between 1-pel and 4-pel motion vector precisions.

A CU coded using IBC mode is treated as a third prediction mode other than intra or inter prediction modes. The IBC mode is applicable to the CUs with both width and height smaller than or equal to 64 luma samples.

At CU level, IBC mode is signalled with a flag, and it can be signaled as IBC AMVP mode or IBC skip/merge mode as follows:

IBC in skip/merge mode: a merge candidate index is used to indicate which of the block vectors in the list from neighboring candidate IBC coded blocks is used to predict the current block. The merge list consists of block vector candidates: spatial, HMVP (history-based motion vector predictor), and pairwise candidates. A pairwise candidate is a candidate that is constructed as an average of 2 other candidates taken from the merge list, usually the first two candidates in the list.

IBC in AMVP mode: a block vector difference is coded in the same way as a motion vector difference, that is the block vector pointing to the reference block is predicted by a block vector predictor and the difference is coded. The block vector prediction method uses two candidates as block vector predictors, one from left neighbor and one from above neighbor (if these neighbors are IBC coded). When either neighbor is not available, a default block vector will be used as a predictor. A flag is signaled to indicate the block vector predictor index.

To limit memory consumption and decoder complexity, the IBC in VVC uses an IBC reference region which comprise only the reconstructed portion of a predefined area including the region of current CTU and some region of the left CTU.

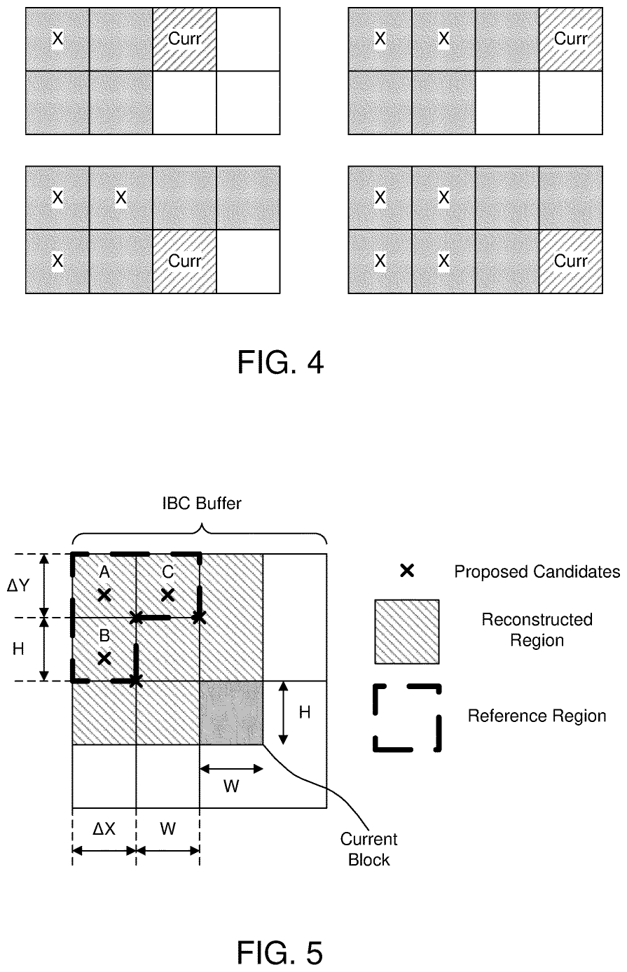

FIG. 4 illustrates the reference region of IBC Mode, where each block represents 64×64 luma sample unit.

Depending on the location of the current CU (Curr) within the current CTU (CTUs are shown with thick black lines in FIG. 4), the following applies:
If a current block falls into the top-left 64×64 block (Curr) of the current CTU, then in addition to the already reconstructed samples in the current CTU, it can also refer to the reference samples in the bottom-right 64×64 blocks of the left CTU. The current block can also refer to the reference samples in the bottom-left 64×64 block of the left CTU and the reference samples in the top-right 64×64 block of the left CTU.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU. Otherwise, the current block can also refer to the reference samples in the bottom-right 64×64 block of the left CTU.
If current block falls into the bottom-right 64×64 block of the current CTU, it can only refer to the already reconstructed samples in the current CTU.

This restriction allows the IBC mode to be implemented using local on-chip memory for hardware implementations.

The IBC merge/AMVP list construction is modified in ECM compared to VVC, modifications are as follows:
Only if an IBC merge/AMVP candidate is valid (for instance it is not a zero vector predictor), it can be inserted into the IBC merge/AMVP candidate list.
Above-right, bottom-left, and above-left spatial candidates and one pairwise average candidate can be added into the IBC merge/AMVP candidate list.
Template based adaptive reordering (ARMC-TM) is applied to IBC merge list.

ARMC-TM is a method that reorders the list of block vector predictor candidates according to cost values based on template matching (TM). For instance, the template matching cost of block vector predictor candidate is measured by the SAD between samples of a template of the current block and their corresponding reference samples. The template comprises a set of reconstructed samples neighboring to the current block. Reference samples of the template are located by the block vector of the candidate. The TM cost for each candidate is determined and used for reordering the candidates in the list based on their TM cost, for instance by increasing order.

The HMVP table size for IBC is increased to 25 entries. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, consequently it is discarded as BVP in the IBC candidate list.

Three candidates are located on the nearest corners of the reference region, and three additional candidates are determined in the middle of the three sub-regions (A, B, and C), whose coordinates are determined by the width and height of the current block and the ΔX and ΔY parameters, as is depicted in FIG. 5.

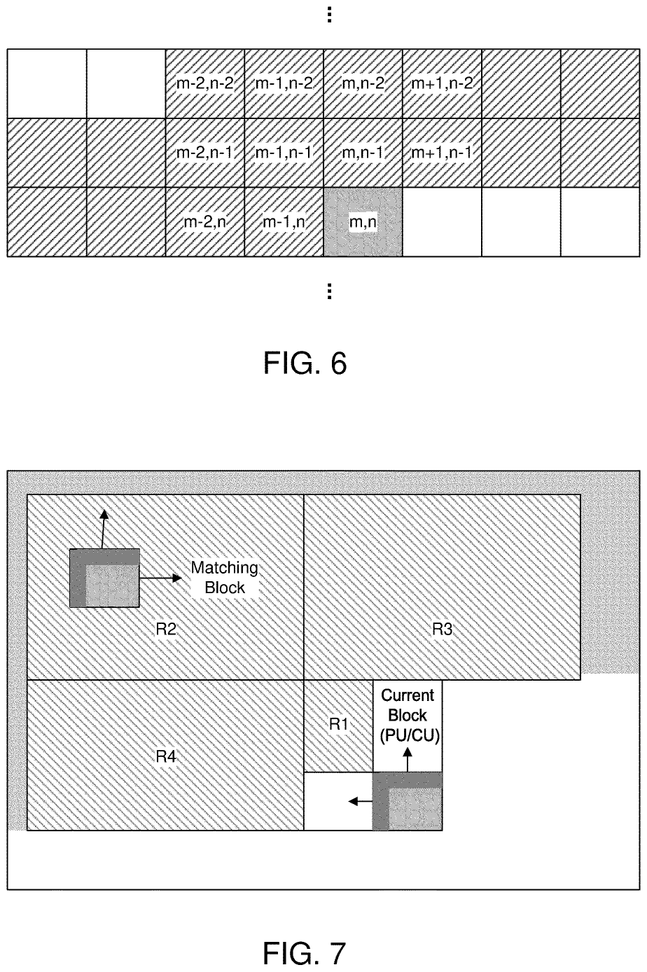

In the document “EEE2-3.2: IBC Reference Area Extension, J. Xu, N. Zhang, JVET-Z0153, JVET meeting 20-29 Apr. 2022′, adopted into ECM version 5.0, the reference area for IBC in ECM is extended to two CTU rows above the CTU being processed by the encoder or the decoder. FIG. 6 illustrates the reference area for coding CTU (m,n). Specifically, for CTU (m,n) to be coded, the reference area includes CTUs with index (m−2,n−2) . . . (W,n−2), (0,n−1) . . . (W,n−1), (0,n) . . . (m−1,n), where W denotes the maximum horizontal CTU index within the current tile, slice or picture. The per-sample block vector search (or called local search) range is limited to [−(C<<1), C>>2] horizontally and [−C, C>>2] vertically to adapt to the reference area extension, where C denotes the CTU size.

Additionally, in ECM-5.0, template matching based motion refinement is applied to the coding mode of Intra Block Copy as follows.

When an IBC-TM merge mode is used, it involves a merge candidate list for Block Vector (BV) prediction, which is different from the merge candidate list used by the regular IBC merge mode (that is without template matching refinement). The candidates are selected according to a pruning method with a motion distance between the candidates as in the regular TM merge mode. The zero motion candidates have been replaced by (−W, 0), (0,−H), (−W, −H) motion vectors (MVs).

In the IBC-TM merge mode, the selected candidates are refined with the template matching method. The TM-merge flag is signalled to indicate the template matching merge IBC mode, so that the candidate can be refined at the decoder using the template matching method.

When an IBC-TM AMVP mode is used, up to 3 candidates are selected from the list of candidates built for the IBC-TM merge mode. Each of those candidates are refined according to the template matching method and are sorted according to their resulting TM cost.

When used with IBC, template matching is used as a motion refinement. TM refinement is performed at integer pel position, and in IBC-TM AMVP mode, it is performed either at integer or 4-pel precision depending on the AMVR value. The TM refinement is done within the defined IBC reference area.

The interaction between IBC mode and other inter coding tools in VVC, such as pairwise merge candidate, history-based motion vector predictor (HMVP), combined intra/inter prediction mode (CIIP), merge mode with motion vector difference (MMVD), and geometric partitioning mode (GPM) is as follows.

IBC can be used with pairwise merge candidate and HMVP. A new pairwise IBC merge candidate can be generated by averaging two IBC merge candidates. For HMVP, IBC motion is inserted into history buffer for future referencing. IBC cannot be used in combination with the following inter tools: affine motion. Since ECM version 8.0, IBC can be used in combination with CIIP, MMVD, and GPM. IBC is not allowed for the chroma coding blocks when DUAL_TREE partition is used.

In VVC, unlike in the HEVC screen content coding extension, the current picture is not included as one of the reference pictures in the reference picture list 0 for IBC prediction. The derivation process of motion vectors for IBC mode excludes all neighboring blocks that are coded in inter mode and vice versa. The following IBC design aspects are applied in VVC:

IBC shares the same process as in regular MV merge including with pairwise merge candidate and history-based motion predictor but disallows TMVP and zero vector because they are invalid for IBC mode.

Separate HMVP buffer (5 candidates each) is used for conventional MV and IBC.

Block vector constraints are implemented in the form of bitstream conformance constraint, the encoder needs to ensure that no invalid vectors are present in the bit-stream, and merge shall not be used if the merge candidate is invalid (out of range or 0). Such bitstream conformance constraint is expressed in terms of a virtual buffer.

For deblocking, IBC is handled as inter mode.

If the current block is coded using IBC prediction mode, AMVR does not use quarter-pel; instead, AMVR is signaled to only indicate whether MV is inter-pel or 4 integer-pel.

The number of IBC merge candidates can be signaled in the slice header separately from the numbers of regular, subblock, and geometric merge candidates.

Intra template matching prediction (Intra TMP) is an intra prediction mode that copies the best prediction block from a reconstructed part of the current frame, whose L-shaped template matches the current template, that is the template of the block to predict. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area as illustrating in FIG. 7 for example, the search area consisting of:
R1: current CTU
R2: top-left CTU
R3: above CTU
R4: left CTU

For example, SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlKW, BlkH) to have a fixed number of SAD comparisons per pixel. That is:

$$SearchRange\_w = a * BlkW$$

$$SearchRange\_h = a * BlkH$$

Where ‘a’ is a constant that controls the gain/complexity trade-off. In practice, ‘a’ is equal to 5. The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

As can be seen from above, ECM supports two separate coding tools, namely intra-block copy and intra template matching, which co-habit in the same codec design and perform similar processes.

Some of the embodiments described herein provide a method that unifies IBC and Intra TMP coding modes, into a single mode, to make the overall ECM codec design cleaner.

According to some of the embodiments described herein the Intra TMP is inserted as a candidate Block Vector predictor inside the IBC AMVP and/or Merge mode, the use of Intra TMP can be signaled by means of the block vector candidate index, either in the IBC AMVP mode, or the IBC merge mode, or both. The CU-level signaling of Intra TMP mode usage is removed.

Furthermore, additional embodiments and variants are described in the following, which can include any one of the following variants:

In IBC AMVP mode, the block vector derived from Intra TMP search is inserted as the first candidate of AMVP candidate list. In a variant, if the mvp_l0_flag syntax element indicates that the first BVP candidate in the AMVP list is used to code the BV information, then no block vector difference is signaled in the bit-stream.

In IBC merge mode, template based adaptive reordering (ARMC-TM) is applied to IBC merge list as in ECM-8.0, including intra template matching BV predictor candidate.

In a variant, in IBC AMVP mode, the Intra TMP candidate is used as the only candidate of the AMVP block vector candidate. Accordingly, the signaling of the BV predictor index used is suppressed in IBC AMVP coding mode.

Multiple Intra TMP candidates are generated, and their associated block vectors are inserted in the IBC AMVP and/or merge candidate list.

Multiple Intra TMP candidates are generated, and their associated block vectors are used to construct pairwise candidate IBC merge candidates.

Mutual exclusivity rule between Intra TMP candidates and usual IBC BV predictor (BVP) candidates can be applied in terms of search spatial regions. For instance, it can be imposed that non-Intra-TMP BVP candidates point to the IBC spatial search area and outside the Intra TMP spatial search area.

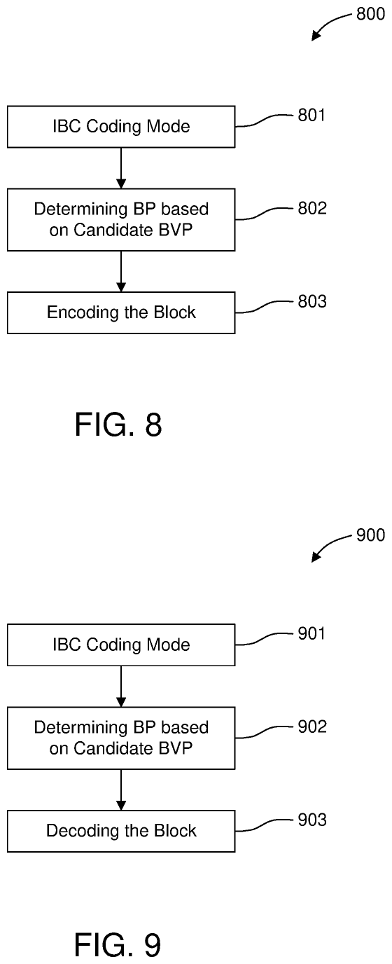

FIGS. 8 and 9 illustrate respectively a method for encoding and decoding an image block according to an embodiment. Any one of the embodiments described and further below can be used in the embodiment described with FIGS. 8 and 9.

FIG. 8 illustrates a method 800 for encoding an image block according to an embodiment. The image block can be a block of an image or a block from a video. At 801, it is determined whether the image block is to be encoded using an intra block copy coding mode. Responsive to the determination that the image block is to be encoded using an intra block copy, at 802, a block predictor is determined for the image block based on one or more candidate block vector predictors. The one or more candidate block vector predictors are included in a list of candidate block vector predictors that can be built according to different variants. For instance, the one or more candidate block vector predictors can be determined as in the VVC or ECM standard in merge or AMVP intra block copy mode. However, according to the embodiment described herein, the one or more candidate block vector predictors comprise at least one candidate block vector predictor that is determined using an intra template matching coding mode.

For determining a block predictor for the image block, for instance, the candidate block vector predictor that provides the lowest rate-distortion cost is selected.

In a variant, the one or more candidate block vector predictors are determined following a given order, and the at least one candidate block vector predictor is determined using an intra template matching coding mode is determined first according to the given order.

In some variants, the candidate block vector predictor can be refined by searching a better block predictor using the candidate block vector predictor as a starting point. In that case, a vector difference between the candidate block vector predictor and the vector of the refined block predictor is signaled to the decoder or in case of IBC in merge mode, refinement can be done using template matching. In a variant, when the candidate block vector predictor is the one determined using the intra template matching coding mode, then no refinement is signaled to the decoder and no vector difference is signaled.

Other variants and embodiments described further below could also be used.

Once the block predictor is determined, at 803, the image block is encoded using the determined block predictor. For instance, residuals are determined between the image block and the block predictor and encoded using residual transform, quantization and entropy encoding.

In some variants, at 803, an indicator is also encoded to signal to the decoder the block vector predictor among the one or more candidate block vector predictors.

FIG. 9 illustrates a method 900 for decoding an image block according to an embodiment. The image block can be a block of an image or a block from a video. At 901, it is determined whether the image block is encoded using an intra block copy coding mode. Responsive to the determination that the image block is encoded using an intra block copy, at 902, a block predictor is determined for reconstructing the image block based on one or more candidate block vector predictors. The one or more candidate block vector predictors are included in a list of candidate block vector predictors that can be built according to different variants. The list is built in a same manner as it is done on the encoder side.

According to the embodiment described herein, the one or more candidate block vector predictors comprise at least one candidate block vector predictor that is determined using an intra template matching coding mode. The block predictor is determined by decoding an indicator signaling which of the one or more candidate block vector predictors to use to determine the block predictor.

In a variant, the one or more candidate block vector predictors are determined following a given order, and the at least one candidate block vector predictor is determined using an intra template matching coding mode is determined first according to the given order.

In some variants, the candidate block vector predictor can be refined by searching a better block predictor using the candidate block vector predictor as a starting point. In that case, a vector difference between the candidate block vector predictor and the vector of the refined block predictor is decoded or the refinement can be done using template matching. In a variant, when the candidate block vector predictor is the one determined using the intra template matching coding mode, then the vector difference is inferred to be 0.

Other variants and embodiments described further below could also be used.

Once the block predictor is determined, at 903, the image block is reconstructed using the determined block predictor. For instance, residuals are decoded using entropy decoding, dequantization and residual inverse transform.

As described above, in an embodiment, the Intra TMP prediction mode is inserted as a particular BV predictor inside the IBC prediction mode. Therefore, the proposed embodiment has some impact on the bit-stream syntax. The following Table 1 and Table 2 illustrate the coding unit level syntax used to signal, in particular, the IBC and Intra TMP in ECM. The IBC dedicated signaling is shown underlined, and the Intra TMP mode signaling is shown in italics. It can be seen that Intra TMP is signaled as a particular intra prediction in ECM.

TABLE 1
coding unit syntax structure according to VVC specification, and partly adapted to
reflect ECM syntax signaling.

| | Descriptor |
|---|---|
| coding_unit( x0, y0, cbWidth, cbHeight, cqtDepth, treeType, modeType ) { | |
| if( sh_slice_type = = \| && ( cbWidth > 64 \| \| cbHeight > 64 ) ) | |
| modeType = MODE_TYPE_INTRA | |
| chType = treeType = = DUAL_TREE_CHROMA ? 1 : 0 | |
| if( sh_slice_type != \| \| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != \| && | |
| !( cbWidth = = 4 && cbHeight = = 4 ) && modeType = = | |
| MODE_TYPE_ALL ) | |
| pred_mode_flag | ae(v) |
| if( ( ( sh slice type = = \| && cu skip flag[ x0 ] [ y0 ]= = 0 ) \| \| | |
| ( sh slice type != \| && ( CuPredMode[ chType ] [ x0 ] [ y0 ] != | |
| MODE INTRA \| \| | |
| ( ( ( cbWidth = = 4 && cbHeight = = 4 ) modeType = | |
| MODE TYPE INTRA ) | |
| && cu skip flag[ x0 ] [ y0 ] = = 0 ) ) ) ) && | |
| cbWidth <= 64 && cbHeight <= 64 && modeType != | |
| MODE TYPE INTER && | |
| sps ibc enabled flag && treeType != DUAL TREE CHROMA ) | |
| pred mode ibc flag | ae(v) |
| } | |
| if( CuPredMode[ chType ][ x0 ][ y0 ] = = MODE_INTRA && | |
| sps_palette_enabled_flag && | |
| cbWidth <= 64 && cbHeight <= 64 && cu_skip_flag[ x0 ][ y0 ] = = 0 && | |
| modeType != MODE_TYPE_INTER && ( ( cbWidth * cbHeight ) > | |
| ( treeType != DUAL_TREE_CHROMA ? 16 : 16 * SubWidthC * SubHeightC | |
| ) ) && | |
| ( modeType != MODE_TYPE_INTRA treeType != | |
| DUAL_TREE_CHROMA ) ) | |
| pred_mode_plt_flag | ae(v) |
| if( CuPredMode[ chType ][ x0 ][ y0 ] = = MODE_INTRA && | |
| sps_act_enabled_flag && | |
| treeType = = SINGLE_TREE ) | |
| cu_act_enabled_flag | ae(v) |
| if( CuPredMode[ chType ][ x0 ][ y0 ] = = MODE_INTRA | |
| CuPredMode[ chType ][ x0 ][ yg0 ] = = MODE_PLT ) { | |
| if( treeType = = SINGLE_TREE \| \| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_intraTmp_enabled_flag && | |
| ! intra_dimd_flag && | |
| cbWidth <= IntraTmpMaxSize && cbHeight <= IntraTmpMaxSize) | |
| intraTmpFlag | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| if( ( treeType = = SINGLE_TREE \| \| treeType = = DUAL_TREE_CHROMA ) | |
| && | |
| sps_chroma_format_idc != 0 ) { | |
| if( pred_mode_plt_flag && treeType = = DUAL_TREE_CHROMA ) | |
| palette_coding( x0, y0, cbWidth / SubWidthC, cbHeight / SubHeightC, | |
| treeType ) | |
| else if( !pred_mode_plt_flag ) { | |
| if( !cu_act_enabled_flag ) { | |
| if( cbWidth / SubWidthC <= MaxTsSize && cbHeight / SubHeightC <= | |
| MaxTsSize | |
| && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| Else | |
| intra_chroma_pred_mode | ae(v) |
| } | |
| } | |
| } | |
| } | |
| } else if( treeType != DUAL_TREE_CHROMA ) { /* MODE_INTER or MODE_IBC | |
| */ | |
| if( cu_skip_flag[ x0 ][ y0 ] = = 0) | |
| general_merge_flag[ x0 ][ y0 ] | ae(v) |
| if( general_merge_flag[ x0 ][ y0 ] ) | |
| merge_data( x0, y0, cbWidth, cbHeight, chType ) | |
| else if( CuPredMode [ chType ] [ x0 ] ] y0 ] = = MODE IBC ) { | |
| mvd coding( x0, y0, 0, 0 ) | |
| if( MaxNumIbcMergeCand > 1 ) | |
| mvp l0 flag [ x0 ] [ y0 ] | ae(v) |
| if( sps amvr enabled flag && | |
| ( MvdL0 [ x0 ] [ y0 ] [ 0 ] != 0 \| \| MvdL0 [ x0 ] [ y0 ] [ 1 ] != 0 ) ) | |
| amvr precision idx [ x0 ] [ y0 ] | ae(v) |
| } else { | |
| [ . . . ] | |
| } | |
| } | |
| [ . . . ] | |
| } | |

TABLE 2
merge data syntax table of the VVC specification,
focused on IBC part signaling

| | Descriptor |
|---|---|
| merge_data( x0, y0, cbWidth, cbHeight, chType ) { | |
| if( CuPredMode [ chType ] [ x0 ] [ y0 ] = = MODE IBC ) { | |
| if( MaxNumIbcMergeCand > 1 ) | |
| merge idx [ x0 ] [ y0 ] | ae(v) |
| } else { | |
| [ . . . ] | |
| } | |

According to the present embodiment, the Intra TMP mode is no more signaled as a particular intra prediction mode. The intra TMP flag is thus removed from the coding unit syntax as shown by Table 3 below.

In addition, the Intra TMP is identified by the syntax element used to indicate the block vector predictor (BVP) used to predict the block vector of current CU.

In the case of the IBC AMVP mode, the mvp_l0_flag syntax element (Table 3) is thus used to identify that Intra TMP is used by to determine the BV predictor of current CU. Other variants are thus possible, for instance using an index rather than a flag to signal the BV predictor in the AMVP mode, thus providing more than two BV predictors in the AMVP mode. In another variant, no syntax element is used to signal the BV predictor, and only the BV predictor provided by the Intra TMP is available.

In the case of the IBC merge mode, the merge_idx syntax element (Table 2) is used to indicate the use of the BVP determined by the Intra TMP mode.

TABLE 3
an example of a coding unit syntax modification according to an embodiment

| | Descriptor |
|---|---|
| coding_unit( x0, y0, cbWidth, cbHeight, cqtDepth, treeType, modeType ) { | |
| if( sh_slice_type = = \| && ( cbWidth > 64 \| \| cbHeight > 64 ) ) | |
| modeType = MODE_TYPE_INTRA | |
| chType = treeType = = DUAL_TREE_CHROMA ? 1 : 0 | |
| if( sh_slice_type != \| \| \| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != \| && | |
| !( cbWidth = = 4 && cbHeight = = 4 ) && modeType = = | |
| MODE_TYPE_ALL ) | |
| pred_mode_flag | ae(v) |
| if( ( ( sh slice type = = \| && cu skip flag [ x0 ] [ y0 ]= = 0) \| \| | |
| ( sh slice type != \| && ( CuPredMode [chType ] [ x0 ] [ y0 ] != | |
| MODE INTRA \| \| | |
| ( ( ( cbWidth = = 4 && cbHeight = = 4 ) modeType = = | |
| MODE TYPE INTRA ) | |
| && cu skip flag [ x0 ] [ y0 ] = = 0 ) ) ) ) && | |
| cbWidth <= 64 && cbHeight <= 64 && modeType != | |
| MODE TYPE INTER && | |
| sps ibc enabled flag && treeType != DUAL TREE CHROMA ) | |
| pred mode ibc flag | ae(v) |
| } | |
| if( CuPredMode[ chType ][ x0 ][ y0 ] = = MODE_INTRA && | |
| sps_palette_enabled_flag && | |
| cbWidth <= 64 && cbHeight <= 64 && cu_skip_flag[ x0 ][ y0 ] = = 0 && | |
| modeType != MODE_TYPE_INTER && ( ( cbWidth * cbHeight ) > | |
| ( treeType != DUAL_TREE_CHROMA ? 16 : 16 * SubWidthC * SubHeightC | |
| ) ) && | |
| ( modeType != MODE_TYPE_INTRA \| \| treeType != | |
| DUAL_TREE_CHROMA ) ) | |
| pred_mode_plt_flag | ae(v) |
| if( CuPredMode[ chType ][ x0 ][ y0 ] = = MODE_INTRA && | |
| sps_act_enabled_flag && | |
| treeType = = SINGLE_TREE ) | |
| cu_act_enabled_flag | ae(v) |
| if( CuPredMode[ chType ][ x0 ][ y0 ] = = MODE_INTRA \| \| | |
| CuPredMode[ chType ][ x0 ][ yg0 ] = = MODE_PLT ) { | |
| if( treeType = = SINGLE_TREE \| \| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| [symbol] [symbol] | |
| [symbol] | |
| [symbol] [symbol] [symbol] | |
| [symbol] | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| if( ( treeType = = SINGLE_TREE \| \| treeType = = DUAL_TREE_CHROMA ) | |
| && | |
| sps_chroma_format_idc != 0 ) { | |
| if( pred_mode_plt_flag && treeType = = DUAL_TREE_CHROMA ) | |
| palette_coding( x0, y0, cbWidth / SubWidthC, cbHeight / SubHeightC, | |
| treeType ) | |
| else if( !pred_mode_plt_flag ) { | |
| if( !cu_act_enabled_flag ) { | |
| if( cbWidth / SubWidthC <= MaxTsSize && cbHeight / SubHeightC <= | |
| MaxTsSize | |
| && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| Else | |
| intra_chroma_pred_mode | ae(v) |
| } | |
| } | |
| } | |
| } | |
| } else if( treeType != DUAL_TREE_CHROMA ) { /* MODE_INTER or MODE_IBC | |
| */ | |
| if( cu_skip_flag[ x0 ][ y0 ] = = 0 ) | |
| general_merge_flag[ x0 ][ y0 ] | ae(v) |
| if( general_merge_flag[ x0 ][ y0 ] ) | |
| merge_data( x0, y0, cbWidth, cbHeight, chType ) | |
| else if( CuPredMode [ chType ] [ x0 ] [ y0 ] = = MODE IBC ) { | |
| mvd coding( x0, y0, 0, 0 ) | |
| if( MaxNumIbcMergeCand > 1 ) | |
| mvp l0 flag [ x0 ] [ y0 ] | ae(v) |
| if( sps amvr enabled flag & | |
| ( MvdL0 [ x0 ] [ y0 ] [ 0 ] != 0 \| \| MvdL0 [ x0 ] [ y0 ] [ 1 ] != 0 ) ) | |
| amvr precision idx [ x0 ] [ y0 ] | ae(v) |
| } else { | |
| [ . . . ] | |
| } | |
| } | |
| [ . . . ] | |
| } | |

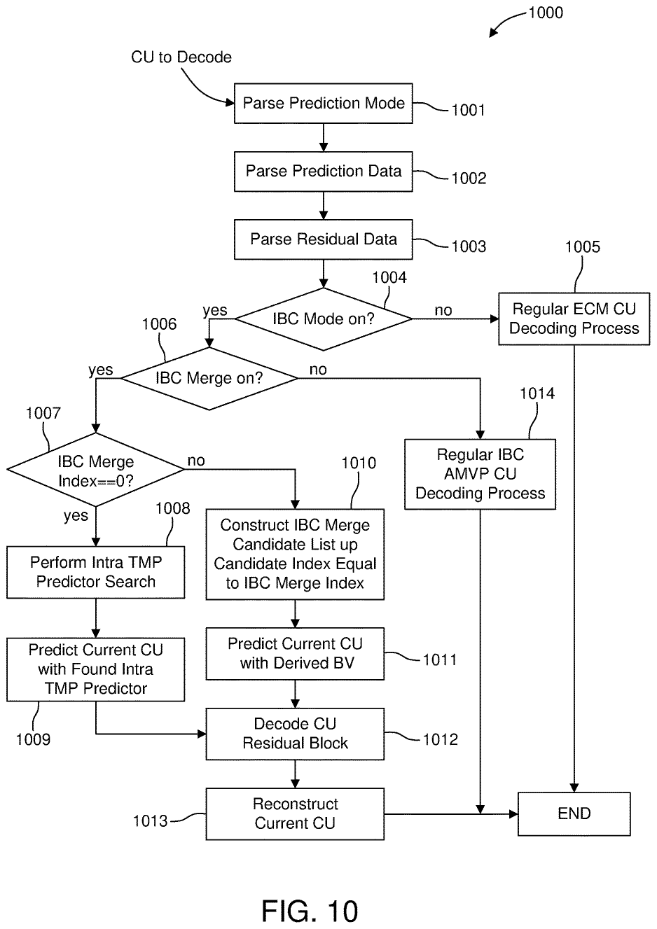

According to a variant, the Intra TMP BVP is only used in the IBC merge candidate list mode and not in the IBC AMVP BVP candidate list. An example of CU decoding process (1000) according to such a variant is illustrated by FIG. 10.

The input to the process is the coding unit (CU) to decode and reconstruct. At 1001, the prediction mode is parsed, along with the prediction parameters of the parsed prediction mode (1002), and the parsing of the CU residual block (1003).

Next, if the IBC mode is not used for the considered CU (1004), then the regular CU decoding process (1005) of ECM takes place. Otherwise (1006), the decoding of the CU depends on whether the IBC merge or the IBC AMVP mode is used for current CU.

If merge mode is on (1006), according to a variant, then the following takes place. If the parsed IBC merge index is equal to 0 (1007), then in this variant, is means the Intra TMP mode is used to derived current CU's block vector. Thus, the Intra TMP predictor search is applied (1008), and the current CU is predicted by the found Itmp predictor (1009), as is done in ECM for the Intra TMP prediction. Otherwise, if IBC merge index is different from 0, then the IBC merge candidate list is constructed (1010) in a similar manner as in ECM, up to the parsed merge index. Then, the CU's block vector is derived (1011) as the IBC merge candidate indicated by the parsed merge index.

The decoding of the CU residual (1012) and CU reconstruction (1013) (adding the residual block and the predicted block) are done as usually done in standard video codecs.

In the case of IBC AMVP mode, that is if it is determined at 1006 that the merge mode is off, then at 1014, the regular IBC AMVP decoding process is employed.

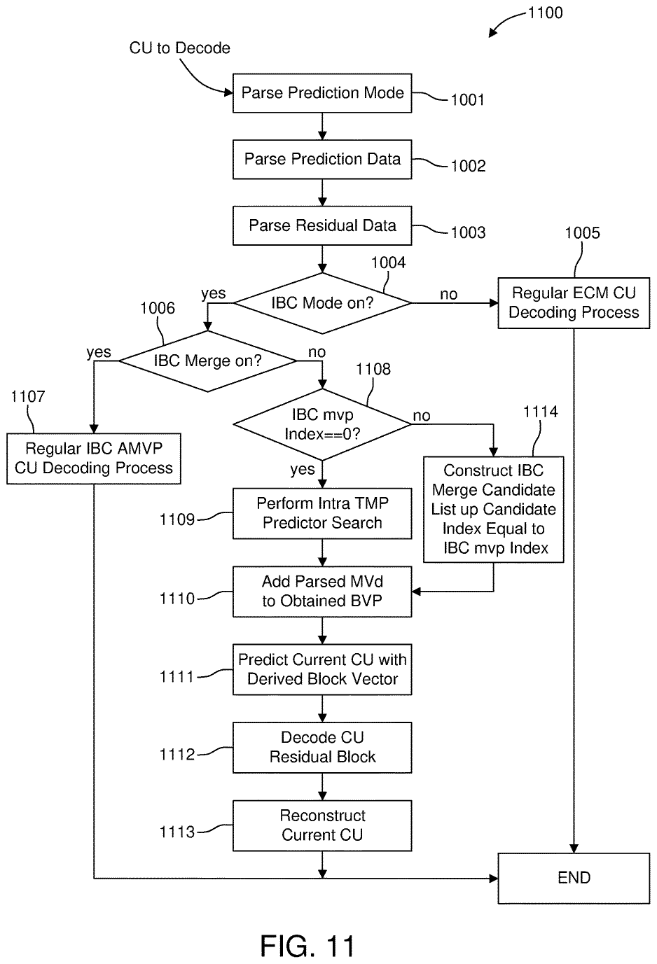

According to another variant, the Intra TMP BVP is only used in the IBC AMVP BVP candidate list mode and not in the IBC merge candidate list. An example of a CU decoding process (1100) according to this variant if depicted by FIG. 11.

The decoding process is similar to the one of FIG. 10, except for the case of IBC merge and IBC AMVP modes. Here, if the CU is in IBC merge mode (1006), then the regular CU decoding process (1107) of ECM is used to decode and reconstruct the current CU. On the contrary, a modified IBC AMVP decoding process is proposed here, which is the following:
At 1108, if the parsed MV predictor index (mvp_l0_flag syntax element) is equal to 0, the Intra TMP prediction mode is used in this variant to reconstruct the BV information of current CU. SO, at 1109, the Intra TMP predictor search is applied, leading to an estimated BV predictor. At 1110, this BVP is added to the parsed BV difference, which provides the reconstructed BV of current CU. Step 1111-1112 and 1113 are the usual residual decoding and CU reconstruction: at 1111 the current CU is predicted with the derived block vector by determining the block predictor pointed by the derived block vector. At 1112, the CU residual block is decoded and at 1113 the current CU is reconstructed by adding the decoded residual and the block predictor.
At 1108, if the MV predictor index is different from 0, then at 1114, the IBC AMVP candidate list is constructed up to the candidate index indicated by the parsed MVP index. The BV predictor of current CU is then set equal to the selected BVP candidate and is added (1110) to the parsed BVd to obtain the CU's reconstructed BV. The CU is then reconstructed through steps 1111-1113.

According to another embodiment, the Intra TMP mode is used to determine BV predictor both for the IBC in merge block vector coding mode and IBC in AMVP block vector coding mode. In this variant, for example step 1107 of FIG. 11 is replaced by steps 1007-1013 of FIG. 10.

It is to be noted that the embodiments described above, the Intra TMP BVP is used as the first candidate in both AMVP and merge BVP candidate lists. In another variant, the Intra TMP may be ranked at any position in the IBC AMVP and/or IBC merge candidate list.

In that case, the list of candidates in the AMVP or merge mode is constructed up to the decoded index.

According to a further embodiment, in the case of IBC in AMVP mode, if the mvp index indicates that Intra TMP predictor is used as the BV predictor in IBC AMVP mode, then no block vector difference (BVD) is signaled in the bit-stream, and the BVD value is inferred to 0 by the decoder.

According to another variant of the IBC AMVP mode, the Intra TMP BV predictor is systematically used as the BV predictor of an IBC AMVP CU. Thus, in this variant, no mvp index is signaled in IBC AMVP mode. A BVD may be signaled and the parsed BVD is added to the Intra-TMP-derived BV predictor to obtain the CU final block vector.

According to a further embodiment of the IBC merge mode, the full merge candidate list, including the Intra TMP BV predictor, is first constructed. Then, a template matching cost-based reordering of IBC merge candidate (ARMC-TM) is applied to the constructed IBC merge list as in ECM-8.0, including intra template matching BV predictor candidate. Thus, the Intra-TMP candidate is put in competition with other merge candidates in this TM-based reordering of merge candidates.

According to a variant, the Intra TMP is put at first position of the IBC merge candidate list, and the TM based reordering of merge candidates only applies to other candidates, i.e. non-Intra-TMP IBC merge candidates.

In a variant, the Intra TMP BV predictor, if used as the BV predictor in current IBC merge coding unit, is inserted into the IBC HMVP table of block vectors successively used in the coding of IBC CUs.

In another variant, the Intra TMP BV predictor, even if used as the BV predictor in current IBC merge coding unit, is never inserted into the IBC HMVP table of block vectors successively used in the coding of IBC CUs.

Other embodiments on IBC merge mode involve multiple Intra TMP BVP candidates. In these embodiments, several Intra TMP BV predictor may be inserted in the IBC AMVP candidate list and/or IBC merge candidate list. For instance, several Intra TMP prediction searches may be performed, for example as in “Non-EE2: IntraTMP with multiple modes”, Po-Han Lin, Jian-Liang Lin, Vadim Seregin, Marta Karczewicz (Qualcomm), document JVET-AC0198, https://jvet-experts.org/doc_end_user/documents/29_Teleconference/wg11/JVET-AC0198-v4.zip, by using different template shapes (top region, left region, top-left region) around the block. These multiple candidates, if different from each other in terms of derived BVP, can be inserted in the IBC AMVP or IBC merge candidate list. Optionally, they may be sorted based according to their template matching cost, normalized per unity of surface.

In a further embodiment, the single or multiple derived Intra TMP BVP may be used to construct pairwise or combined IBC merge candidates, when constructing the IBC merge candidate list.

According to a further embodiment, some mutual exclusivity rule between Intra TMP candidates and usual IBC BV predictor (BVP) candidates may be applied in terms of search spatial regions.

For instance, with respect to IBC AMVP mode, the non-Intra-TMP BV predictors may consist of BV predictor pointing out of the Intra TMP search region. The advantage of such rule is that it would avoid any potential redundancy between the Intra TMP and non Intra TMP BV predictor, in the construction of the IBC candidate list.

Such rule may also be applied between Intra TMP and non-Intra-TMP BVP candidates in the IBC merge mode.

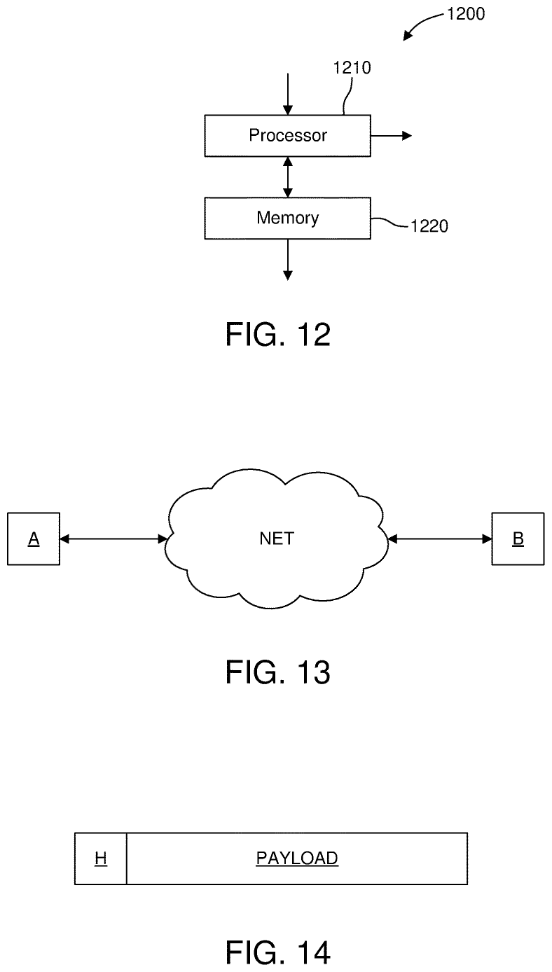

FIG. 12 illustrates a block diagram of a system within which aspects of the present embodiments may be implemented, according to another embodiment. FIG. 12 shows one embodiment of an apparatus 1200 for encoding or decoding an or a video according to any one of the embodiments described herein. The apparatus comprises Processor 1210 and can be interconnected to a memory 1220 through at least one port. Both Processor 1210 and memory 1220 can also have one or more additional interconnections to external connections. Processor 1220 is also configured to responsive to a determination that an image block is encoded using an intra block copy coding mode, determine a block predictor for the image block based on one or more candidate block vector predictors, wherein the one or more candidate block vector predictors comprises at least one candidate block vector predictor determined using an intra template matching coding mode, and encode the image block using the determined block predictor, using any one of the embodiments described herein. For instance, the processor 1220 is configured using a computer program product comprising code instructions that implements any one of embodiments described herein.

In other embodiments, Processor 1220 is configured to responsive to a determination that an image block is encoded using an intra block copy coding mode, determine a block predictor for the image block based on one or more candidate block vector predictors, wherein the one or more candidate block vector predictors comprises at least one candidate block vector predictor determined using an intra template matching coding mode, and decode the image block using the determined block predictor, using any one of the embodiments described herein. For instance, the processor 1220 is configured using a computer program product comprising code instructions that implements any one of embodiments described herein.

In an embodiment, illustrated in FIG. 13, in a transmission context between two remote devices A and B over a communication network NET, the device A comprises a processor in relation with memory RAM and ROM which are configured to implement a method for encoding an image or a video, as described with FIG. 1-11 and the device B comprises a processor in relation with memory RAM and ROM which are configured to implement a method for decoding an image or a video as described in relation with FIG. 1-11. In accordance with an example, the network is a broadcast network, adapted to broadcast/transmit a coded video from device A to decoding devices including the device B.

FIG. 14 shows an example of the syntax of a signal transmitted over a packet-based transmission protocol. Each transmitted packet P comprises a header H and a payload PAYLOAD. In some embodiments, the payload PAYLOAD may comprise image or video data encoded according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image or video data.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method, comprising:
responsive to a determination that an image block is encoded using an intra block copy coding mode in a merge mode, determining a block predictor for the image block based on one or more candidate block vector predictors,
wherein the one or more candidate block vector predictors comprise at least one candidate block vector predictor determined using an intra template matching coding mode, and
encoding the image block using the determined block predictor.

2. An apparatus, comprising one or more processors, wherein the one or more processors are operable to:
responsive to a determination that an image block is encoded using an intra block copy coding mode in a merge mode, determine a block predictor for the image block based on one or more candidate block vector predictors,
wherein the one or more candidate block vector predictors comprise at least one candidate block vector predictor determined using an intra template matching coding mode, and
encode the image block using the determined block predictor.

3. A method, comprising:
responsive to a determination that an image block is encoded using an intra block copy coding mode in a merge mode, determining a block predictor for the image block based on one or more candidate block vector predictors,
wherein the one or more candidate block vector predictors comprise at least one candidate block vector predictor determined using an intra template matching coding mode, and
decoding the image block using the determined block predictor.

4. An apparatus, comprising one or more processors, wherein the one or more processors are operable to:
responsive to a determination that an image block is encoded using an intra block copy coding mode in a merge mode, determine a block predictor for the image block based on one or more candidate block vector predictors,
wherein the one or more candidate block vector predictors comprise at least one candidate block vector predictor determined using an intra template matching coding mode, and
decode the image block using the determined block predictor.

5. The method of claim 3, wherein determining a block predictor for the image block based on one or more candidate block vector predictors comprises decoding an indicator indicating a block vector predictor among the one or more candidate block vector predictors for determining the block predictor.

6. The method of claim 1, wherein determining a block predictor for the image block based on one or more candidate block vector predictors comprises encoding an indicator indicating a block vector predictor among the one or more candidate block vector predictors for encoding the image block.

7. The method of claim 5, the one or more candidate block vector predictors being determined following a given order, the at least one candidate block vector predictor determined using an intra template matching coding mode is determined first according to the given order.

8. The method of claim 5, wherein responsive to a determination that the intra block copy coding mode is an advanced motion vector prediction (AMVP) mode, and responsive to a determination that the indicator indicates that the block vector predictor is the at least one candidate block vector predictor determined using an intra template matching coding mode, a vector difference for the block predictor is inferred to be 0.

9. (canceled)

10. The method of claim 7, wherein the one or more candidate block vector predictors are reordered according to a template-based adaptive reordering except for the at least one candidate block vector predictor determined using the intra template matching coding mode.

11. (canceled)

12. The method of claim 3, wherein at least one pairwise candidate block vector predictor is obtained using at least two candidate block vector predictors, and wherein at least one of the two candidate block vector predictors is determined using an intra template matching coding mode.

13-15. (canceled)

16. The method of claim 3, wherein more than one candidate block vector predictor is determined using an intra template matching coding mode by using different template shapes and included in the one or more candidate block vector predictors.

17. The method claim 16, wherein the more than one candidate block vector predictor determined using an intra template matching coding mode is sorted according to a normalized template matching cost.

18. (canceled)

19. A non-transitory computer readable medium storing executable program instructions to cause a computer executing the program instructions to perform a method according to claim 3.

20-21. (canceled)

22. The apparatus of claim 4, comprising:
at least one of (i) an antenna configured to receive or transmit a signal, the signal including data representative of the image block, (ii) a band limiter configured to limit the signal to a band of frequencies that includes the data representative of the image block, or (iii) a display configured to display the image block.

23. (canceled)

24. The apparatus of claim 4, wherein determining a block predictor for the image block based on one or more candidate block vector predictors comprises decoding an indicator indicating a block vector predictor among the one or more candidate block vector predictors for determining the block predictor.

25. The apparatus of claim 2, wherein determining a block predictor for the image block based on one or more candidate block vector predictors comprises encoding an indicator indicating a block vector predictor among the one or more candidate block vector predictors for encoding the image block.

26. The apparatus of claim 24, the one or more candidate block vector predictors being determined following a given order, the at least one candidate block vector predictor determined using an intra template matching coding mode is determined first according to the given order.

27. The apparatus of claim 26, wherein the one or more candidate block vector predictors are reordered according to a template-based adaptive reordering except for the at least one candidate block vector predictor determined using the intra template matching coding mode.

28. The apparatus of claim 4, wherein at least one pairwise candidate block vector predictor is obtained using at least two candidate block vector predictors, and wherein at least one of the two candidate block vector predictors is determined using an intra template matching coding mode.
